(19) United States
(12) Patent Application Publication
(10) Pub. No.: US 2002/0140134 A1
(43) Pub. Date: Oct. 3, 2002

(54) AIN substrate and method for preparing such substrate for bonding to a copper foil

(75) Inventor: Herbert Topitsch, Wien (AT)

Correspondence Address: HENRY M FEIEREISEN, 350 FIFTH AVENUE, SUITE 3220, NEW YORK, NY, 10118, US

(73) Assignee: ELECTROVAC, FABRIKATION ELEKTROTECHNISCHER SPEZIALARTIKEL GESELLSCHAFT M.B.H., Klosterneuburg (AT)

(21) Appl. No.: 10/094,784

(22) Filed: Mar. 11, 2002

(30) Foreign Application Priority Data
Mar. 16, 2001 (EP) 018 90 082.9

(51) Int. Cl. B28B 1/00

(52) U.S. Cl. 264/614

(57) ABSTRACT

An AlN substrate is disclosed that can be bonded to a copper foil by a direct-copper-bonding (DCB) method. The bonding surface of the AlN substrate includes at least one auxiliary layer containing at least 50 wt. % CuAlO₂ and an excess of Cu₂O. Also disclosed is a process for preparing the auxiliary layer by applying a material containing copper, copper oxide and/or other copper-containing compounds, followed by an oxidation and reduction process.

### CROSS-REFERENCES TO RELATED APPLICATIONS

This application claims the priority of European Patent Application Serial No. 018 90 082.9, filed Mar. 16, 2001, the subject matter of which is incorporated herein by reference.

### BACKGROUND OF THE INVENTION

The present invention relates to an AlN substrate adapted for bonding to a copper foil, as well as to a method for preparing an AlN substrate for bonding to a copper foil using a direct-copper-bonding (DCB) method.

Copper-ceramic sandwich substrates have found increasing applications over the past years for cost-effective fabrication of semiconductor devices for intelligent power controls. Highly efficient circuit boards made with these material are known as DCB (direct copper bonded) substrates. These boards greatly improve thermal management of high-power electronic devices. The ceramic material Al₂O₃ with a thermal conductivity of between 20 and 35 W/(m*K) is typically used for these applications. With the tendency for increased integration and miniaturization of high-power electronic devices, more and more heat is produced in increasingly smaller areas. It would therefore be desirable to replace aluminum oxide with aluminum nitride which has a significantly higher thermal conductivity than aluminum oxide (up to 350 W/(m*K) vs. 35 W/(m*K)). Moreover, the thermal expansion coefficient of AlN matches more closely that of Si. The thermal expansion coefficient of AlN is approximately 5×10⁻⁶/° C., that of Si is approximately 4×10⁻⁶/° C. and that of Al₂O₃ is approximately 8×10⁻⁶/° C. This is another reason why the use of AlN is more desirable. Today's AlN substrate size is typically in the range between 1×1 inch and 2×2 inch. Larger substrate sizes are desirable for economic reasons. The maximum substrate size that can be manufactured with today's technology is 5×7 inches.

Disadvantageously, the DCB process commonly employed with Al₂O₃ cannot be used with AlN because the eutectic melt, which includes copper oxide/copper, does not wet the AlN ceramic substrate. Various processes have been proposed to bond copper foils to AlN ceramic substrates. For example, special materials have been added to the AlN ceramic substrate to produce a surface that is suitable for bonding. Other processes use a specially treated surface of the AlN ceramic substrate to facilitate wetting by the eutectic melt.

For example, German Pat. No. DE 9407157 discloses the addition of alloying agents in addition to conventional annealing agents. A total amount of all agents between 0.1% and 7 wt. % oxygen was suggested for producing an oxide layer with an optimum density during surface oxidation. The disclosed method has the disadvantage that the large quantity of additional alloying agent substantially reduces the thermal conductivity.

German Pat. No. DE 3534886 describes another method wherein the surface is subjected to a special heat treatment to promote adhesion of the metal foil. This heat treatment to reduce the surface roughness to less than 10 μm.

European Pat. No. EP 516 819, U.S. Pat. No. 5,418,002 and International Patent publication WO 92/11113 describe oxidation of AlN in an atmosphere containing water vapor. The surface produced in this manner has good bonding characteristics. This process is described for substrate sizes of 2×2 inch where the difference in the thermal expansion coefficients is not yet of critical importance. However, the process apparently does not work with larger substrates. For a substrate size of 5×7 inch, the difference in the thermal expansion between AlN and Al₂O₃ alone causes a difference in length of more than approximately 1 mm. More particularly, a difference in length of 3 mm for the long side (7 inch) of the substrate is calculated at the high temperature of 1250° C. disclosed in the patent due to the difference in the thermal expansion coefficients between the oxide and the nitride layer.

U.S. Pat. No. 5,275,770 and German Pat. No. DE 38 44 264 describe the production of a composite devices made of AlN and Al₂O₃. It appears to be possible to bond copper to such composite devices using the DCB process. German Pat. No. DE 41 04 860 discloses the formation of an oxide layer under a controlled moisture-free oxidizing atmosphere. Copper is bonded to this surface using the DCB process.

Other patents describe the application of an oxide layer by spinning, flame spraying, screen printing or simultaneous annealing of Al₂O₃ and AlN. The present applicant conducted comprehensive experiments, but was unable to produce homogeneous bubble-free copper-ceramic compounds by using this process.

German Pat. No. DE 196 03 822 C2 describes the application of a thin layer of copper, copper oxide or other copper-containing compounds to an AlN ceramic substrate. This layer is treated in an oxygen atmosphere at approximately 1280° C., which produces an auxiliary layer on the AlN surface. This auxiliary layer consists essentially of Al₂O₃ and contains a copper oxide. A copper foil is bonded to this auxiliary layer using a conventional DCB process.

The present applicant conducted comprehensive experiments and was unable to repeat these results. In particular, it was observed that the applied copper foil melts during bonding. Analysis of the experiments showed that the CuO produced in the oxidation process is reduced under the bonding conditions to Cu₂O with the simultaneous release of oxygen. The additional oxygen alters the atmosphere during the bonding process by creating excess oxygen; this causes the copper foil in contact with the substrate to melt (see FIG. 4, which shows a photograph of a copper foil that melted during the bonding process).

JP 6321663 describes the application of Cu, Cu₂O or CuO. The material is in powder form and dispersed in a polymer and subsequently thermally oxidized at temperatures between 700° C. and 900° C. This method also does not yield reproducible results, since even small deviations cause the results to be different.

It would therefore be desirable and advantageous to provide an AlN substrate, in particular an AlN substrate with an auxiliary layer, wherein a copper foil can be attached to the auxiliary layer using a direct copper bonding (DCB) process. It would also be desirable and advantageous to provide a method for preparing an AlN substrate for bonding to a copper foil using the direct copper bonding (DCB) process. The AlN substrate and the method are intended to qualitatively improve the reproducibility of the bonding processes and to facilitate defect-free bonding of large-area copper foils (>4×4 inch) to the AlN substrate.

### SUMMARY OF THE INVENTION

According to one aspect of the invention, an AlN substrate is provided that can be bonded to a copper foil by a direct-copper-bonding (DCB) method. At least one auxiliary layer is disposed on at least one surface of the AlN substrate. The auxiliary layer contains at least 50 wt. % CuAlO₂ and furthermore an excess of Cu₂O.

According to another aspect of the invention, a method for preparing an AlN substrate for bonding to a copper foil using a direct copper bonding (DCB) process includes producing an auxiliary layer on least one surface of the AlN substrate, wherein the auxiliary layer contains copper, copper oxide and/or other copper-containing compounds such as CuNO₃ (copper nitrate) and Cu₃N (copper nitride). The auxiliary layer is then oxidized to form CuAl₂O₄ in the auxiliary layer. Thereafter, the oxidized auxiliary layer is reduced to convert the CuAl₂O₄ contained in the oxidized auxiliary layer to CuAlO₂ and to convert any CuO contained in the oxidized auxiliary layer to Cu₂O.

The afore-described method makes it possible to reproducibly bond defect-free large-area copper foils (>4×4 inches) to AlN substrates.

The auxiliary layer according to the invention, unlike conventional layers applied to the AlN substrate that are predominantly composed of Al₂O₃ to promote wettability by the Cu/CuO eutectic, is predominantly composed of CuAlO₂. The reduction step eliminates AlO, CuAl₂O₄ and CuO from the reduced auxiliary layer which tend to release oxygen during the bonding process and thereby cause defect formation between the AlN substrate and the copper foil in conventional processes. This is of particular importance when large-area copper foils are to be bonded to the AlN substrate.

Embodiments of the invention may include one or more of the following features. The auxiliary layer can contain between 30 and 50 wt. % Cu₂O. The presence of Cu₂O in the auxiliary layer of the invention significantly improves wetting by a Cu/CuO eutectic formed during bonding of the copper layer. It has been observed that the disclosed fractions of Cu₂O provide a particularly good wettability of the auxiliary layer and therefore also good bonding results.

The oxidation may be carried out in an ambient air atmosphere. This eliminates the need for a special atmosphere and makes the process of the invention technically less complex.

Advantageously, the oxidation process can be carried out at a temperature between 1065° C. and 1080° C., and more particularly at a temperature of approximately 1075° C. These temperatures are easily achievable, while the time required for forming the mixed crystal CuAl₂O₄ by oxidation is still relatively short. The process of the invention can therefore be carried out efficiently at these temperatures.

The reduction process can be carried out in a nitrogen atmosphere which can contain up to 1000 ppm oxygen. Using this atmosphere has the advantage that the furnace settings, i.e., furnace temperature, temperature ramping and the furnace atmosphere, can be selected to be identical to those used in the subsequent bonding process. This makes the process of the invention technically less complex and less expensive.

Advantageously, the reduction process can be carried out at a temperature between 1065° C. and 1080° C., and more particularly at a temperature of approximately 1070° C. These operating temperatures make the process very efficient, because these temperatures can be easily achieved, while the time required for the reduction process is still relatively short.

The reduction process may also be carried out at a reduced pressure in the range of<1 bar. Operating at reduced pressure, as compared to normal pressure, accelerates the chemical reactions taking place during the reduction process so that the process duration can be shortened.

The auxiliary layer that contains copper, copper oxide or other copper-containing compounds can have a thickness of between 0.14 μm and 2 μm, preferably between 0.5 μm and 2 μm; most preferred is a thickness of approximately 1 μm. This layer thickness has been found to provide an optimal quantity of CuAlO₂ for the bonding process.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a vertical cross-section through an AlN substrate produced by a method according to the invention;

FIG. 2 is an X-ray diffraction pattern of the AlN substrate of FIG. 1 after oxidation;

FIG. 3 is an X-ray diffraction pattern of the AlN substrate of FIG. 2 after reduction;

FIG. 4 shows a photograph of a copper foil that is bonded to a conventionally pretreated AlN substrate; and

FIG. 5 shows a photograph of a copper foil that is bonded to an AlN substrate prepared with the process of the invention.

### DETAILED DESCRIPTION OF PREFERRED EMBODIMENTS

Throughout all the Figures, same or corresponding elements are generally indicated by same reference numerals.

Turning now to the drawing, and in particular to FIG. 1, there is shown a substrate designated with the reference numeral 1 and including a layer 10 essentially made of aluminum nitride (AlN). The layer 10 need not be pure AlN, but may also include other impurities, such as various yttrium compounds. Reference numeral 2 designates a copper foil which is to be bonded to the AlN substrate 1 by using a conventional direct copper bonding (DCB) process.

AlN is typically not wetted by a Cu/CuO eutectic which precludes bonding to an AlN surface. For this reason, an auxiliary layer 4 is disposed on the surface to which a copper foil 2 is to be attached. The composition of the auxiliary layer 4 is selected so that it is wetted by the Cu/CuO eutectic, allowing a copper foil 2 to be attached to the auxiliary layer 4 using a conventional direct copper bonding (DCB) process. If copper foils 2 are to be bonded to both surfaces of an AlN substrate 1 instead of only to one surface as depicted in FIG. 1, then an auxiliary layer 4 must obviously be applied to both surfaces.

The surface of the copper foil 2 to be bonded to the AlN substrate 1 can be provided with an oxide layer 3, which can supply the oxygen required for forming the Cu/CuO eutectic. If a sufficient quantity of oxygen can be supplied in other ways, for example by the auxiliary layer 4 disposed on the AlN substrate 1, then the oxide layer 3 on the copper foil 2 can be omitted.

According to the invention, the auxiliary layer 4 which enables bonding of the copper foil 2, is primarily formed of CuAlO₂ and contains at least 50 wt. % CuAlO₂. The layer also contains Cu₂O, preferably between 30 and 50 wt. % Cu₂O.

Various methods known in the art can be used to prepare an auxiliary layer having this composition. For example, CuAlO₂ and Cu₂O can be prepared separately from the AlN substrate 1 and subsequently applied to the AlN substrate 1 by mechanical processes (e.g., by screen printing or the addition of CuAlO₂ and Cu₂O to a solvent (e.g., alcohol) and subsequent application of this suspension to the substrate 1).

Preferably, the auxiliary layer is prepared by a mechanical-chemical process described below.

With this process, the auxiliary layer 4 is prepared by applying a layer of copper, copper oxide or other copper-containing compounds to at least one surface of the AlN substrate 1.

Details of the application of this layer 4 are not part of the invention and several methods known in the art can be used. Copper, copper oxide and the other copper-containing compounds can be applied, for example, by sputtering, electroless deposition of copper in a conventional bath, evaporation, screen printing, dipping into a solution and the like.

Preferably, a suspension of copper and/or copper oxide and/or other copper-containing compounds in isopropyl alcohol or another organic solvent is prepared. This suspension can be sprayed onto the AlN substrate and the organic solvent is subsequently allowed to evaporate.

The thickness of the applied layer made of copper, copper oxide or other copper-containing compounds is in a range between 0.14 μm and 2 μm; typically the thickness is between 0.5 μm and 2 μm, and more particularly approximately 1 μm.

The AlN substrate 1 is subsequently subjected to an oxidation process, wherein the copper, copper oxide and/or other copper-containing compounds are oxidized, forming a CuAl₂O₄ mixed crystal in the layer. The copper, copper oxide or other copper-containing compounds are applied to the AlN substrate in a quantity greater than that required for producing the CuAl₂O₄ mixed crystal. Accordingly, excess CuO is present at the end of the oxidation process, which essentially prevents the formation of harmful Al₂O₃.

The elimination of the formation of Al₂O₃ has been confirmed by the following experiment: AlN powder was mixed with Cu₂O powder and the mixture was subsequently oxidized. This resulted predominantly in the formation of CuAl₂O₄ mixed crystals and CuO, and no measurable quantities of Al₂O₃ were detected.

In the afore-described oxidation process, the AlN substrate 1 is heated in an oxygen-containing atmosphere, preferably ambient air, to temperatures between 800° C. and 1300° C. Temperatures between 1065° C. and 1080° C. have proven to be particularly advantageous.

The AlN substrate 1 is held at these temperatures until the required CuAl₂O₄ mixed crystals form and cover the entire surface area. The duration of the actual oxidation depends on the selected temperature as well as on the composition and the pressure of the oxidizing atmosphere.

Those skilled in the art will be able to select these parameters both individually and in combination. The duration of the oxidation can last between 12 hours and 10 minutes.

At the end of this oxidation process, the layer contacting the AlN substrate 1 contains CuO in addition to CuAl₂O₄.

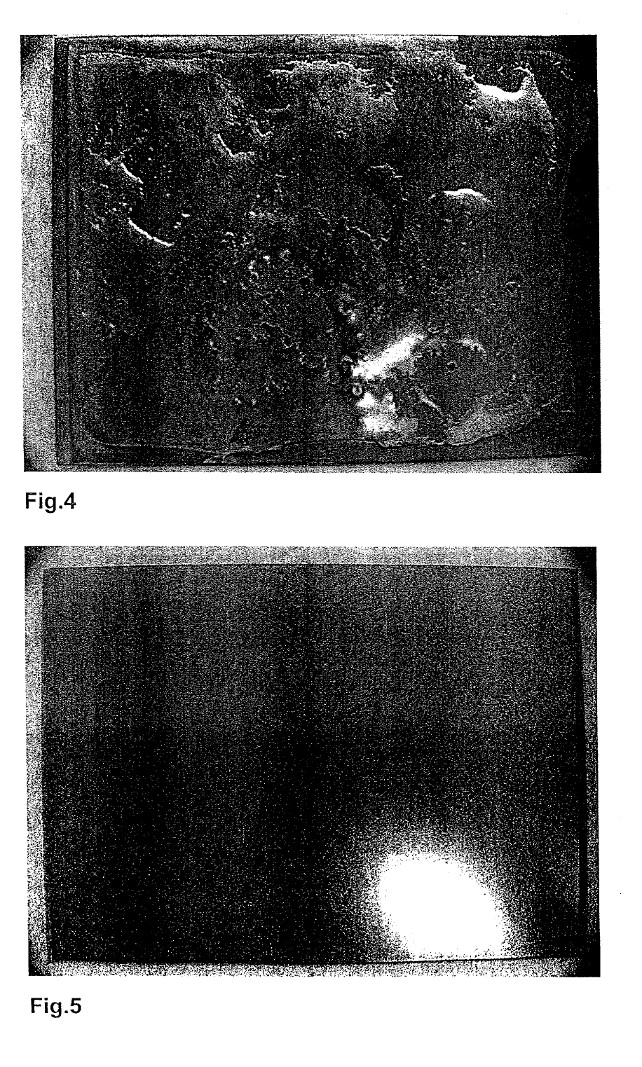

If the copper foil would be bonded to the AlN substrate 1 by the DCB process immediately at the conclusion of the oxidation process, then oxygen could be released from the CuAl₂O₄ mixed crystal during bonding. The excess oxygen could prevent the bonds from uniformly covering the entire surface, because the oxygen concentration may be higher locally in the region of the Cu/CuO eutectic. Experimental results suggest that this could cause the contacting copper foil to melt (see FIG. 4).

This effect can be prevented according to the invention by implementing another pre-treatment step, namely a reduction process, wherein the CuAl₂O₄ in the layer is reduced to CuAlO₂ and the CuO in the layer is reduced to Cu₂O.

This reduction process is carried out by subsequently heating the AlN substrate 1 in a nitrogen-containing atmosphere to a temperature between 800° C. and 1300° C. Particularly advantageous temperatures are between 1065° C. and 1080° C. The atmosphere in which the reduction process is carried out, can contain oxygen. For example, a nitrogen atmosphere can be used which contains up to 1000 ppm oxygen.

During the reduction process, the atmosphere surrounding the AlN substrate 1 can be at normal pressure. Alternatively, the reduction process can be carried out at a reduced pressure, for example, at a pressure of<1 bar.

The duration of the reduction process, i.e., the time period during which the AlN substrate 1 should be heated, depends on the actually selected temperature as well as on the actual composition and pressure of the reducing atmosphere.

These parameters must be selected and matched to one another, which those skilled in the art will be easily able to do, so that the CuAl₂O₄ molecules are reduced to CuAlO₂, and likewise the CuO molecules are reduced to Cu₂O. This reaction can last between 12 hours and one minute.

The preparation of the auxiliary layer 4 according to the invention concludes with the reduction process. As stated repeatedly, the auxiliary layer 4 then contains at least 50 wt. % CuAlO₂, as well as Cu₂O. A copper foil 2 can now be applied to the auxiliary layer 4 by a conventional DCB process which will not be described in detail. The copper foil 2 is thereby bonded to the AlN substrate 1 across its entire surface, as depicted in the photograph of FIG. 5. Moreover, local melting of the copper foil 2 as well as bubbles or other defects are eliminated.

The experimental results of an exemplary embodiment will now be described in detail, without limiting the scope of the invention:

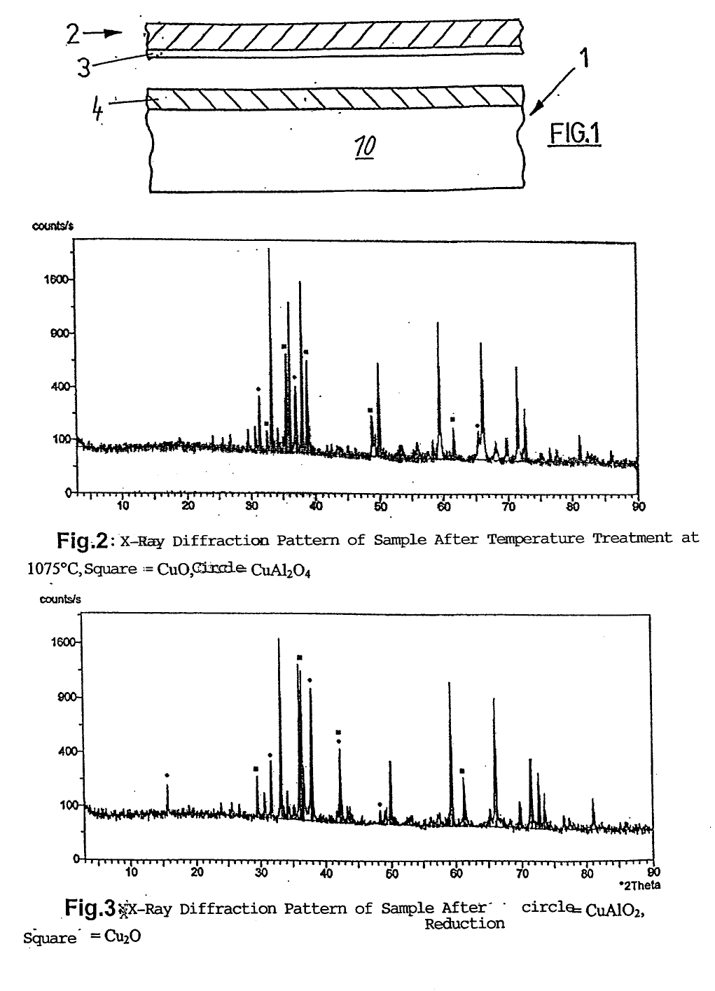

An AlN substrate 1 having a size of 5×7 inches and a thickness of 0.63 mm is coated with a suspension consisting of Cu₂O and isopropyl alcohol. Approximately 30 to 50 mg of Cu₂O are applied to each surface. The treated AlN substrate 1 was heated in a furnace in an air ambient to 1075° C., held at that temperature for 0.5 hours and subsequently cooled to room temperature over at least 5 hours. During that time, CuAl₂O₄ and/or CuO is formed in the layers applied to the AlN substrate 1, as seen in the X-ray diffraction pattern of FIG. 2. The peaks in the X-ray diffraction pattern without reference numerals are produced by the AlN in the substrate 1 and/or by mixed phases of AlN with other compounds that promote annealing, as described above.

After the oxidation process, the AlN substrate 1 is subjected to a reduction step by heating the substrate 1 once more to a temperature of greater than 1065° C. This heating step is performed in a nitrogen atmosphere containing 200 ppm oxygen. The temperature of 1065° C. was maintained for several minutes.

The CuAl₂O₄ produced during the oxidation process was hereby reduced to CuAlO₂ and excess CuO was likewise reduced to Cu₂O (see the X-ray diffraction pattern of FIG. 3; the peaks without reference numerals are again produced by AlN and/or by mixed phases of AlN with other compounds that promote annealing).

No measurable quantities of Al₂O₃ (which is the oxide that essentially forms the auxiliary layer 4 of conventional structures) were detected.

After the AlN substrate 1 was cooled, copper foils 2 were attached on both surfaces of the AlN substrate 1 using the DCB process. In all cases, the bond was free from defects and covered the entire area.

While the invention has been illustrated and described as embodied in an AlN substrate and method for preparing such substrate for bonding to a copper foil, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. AlN substrate adapted for bonding to a copper foil by a direct-copper-bonding (DCB) method, wherein at least one auxiliary layer is disposed on at least one surface of the AlN substrate, said at least one auxiliary layer containing at least 50 wt. % CuAlO₂ and an excess of Cu₂O.

2. The AlN substrate of claim 1, wherein the auxiliary layer contains between 30 and 50 wt. % CU₂O.

3. A method for preparing an AlN substrate for bonding to a copper foil using a direct copper bonding (DCB) process, comprising the steps of:
producing an auxiliary layer on least one surface of the AlN substrate,
wherein the auxiliary layer comprises a material selected from the group consisting of copper, copper oxide and copper-containing compounds;
oxidizing the auxiliary layer so as to form CuAl₂O₄ in the auxiliary layer; and
reducing the oxidized auxiliary layer so as to convert the CuAl₂O₄ contained in the oxidized auxiliary layer to CuAlO₂ and to convert any CuO contained in the oxidized auxiliary layer to CU₂O.

4. The method of claim 3, wherein the auxiliary layer is oxidized in an ambient air atmosphere.

5. The method of claim 3, wherein the auxiliary layer is oxidized at a temperature between 1065° C. and 1080° C.

6. The method of claim 5, wherein the auxiliary layer is oxidized at a temperature of approximately 1075° C.

7. The method of claim 3, wherein the oxidized auxiliary layer is reduced in a nitrogen atmosphere.

8. The method of claim 7, wherein the nitrogen atmosphere contains up to 1000 ppm oxygen.

9. The method of claim 3, wherein the oxidized auxiliary layer is reduced at a temperature between 1065° C. and 1080° C.

10. The method of claim 9, wherein the oxidized auxiliary layer is reduced at a temperature of approximately 1070° C.

11. The method of claim 3, wherein the oxidized auxiliary layer is reduced at a pressure of less than 1 bar.

12. The method of claim 3, wherein the auxiliary layer has a layer thickness of between 0.14 μm and 2 μm

13. The method of claim 12, wherein the auxiliary layer has a layer thickness of between 0.5 μm and 2 μm.

14. The method of claim 12, wherein the auxiliary layer has a layer thickness of approximately 1 μm.
